(19) United States
(12) Patent Application Publication
(10) Pub. No.: US 2005/0203260 A1
(43) Pub. Date: Sep. 15, 2005

(54) Catalyst composition for polymerization of olefins and polymerization process using the same

(76) Inventors: Wei Xu, Riyadh (SA); Haif Al-Shammari, Riyadh (SA); Syriac Palackal, Riyadh (SA); Atieh Abu-Raqabah, Riyadh (SA)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/078,020

(22) Filed: Mar. 11, 2005

(30) Foreign Application Priority Data
Mar. 12, 2004 (EP) EP 04005939.6

(51) Int. Cl. C08F 4/44; B01J 31/00

(52) U.S. Cl. 526/134; 526/348.5; 526/348.6; 526/160; 526/943; 526/161; 526/172; 502/117

(57) ABSTRACT

The present invention relates to a catalyst composition for polymerization of olefins comprising at least two catalytic components; and the polymerization process using that catalyst composition.

The present invention relates to a catalyst composition for polymerization of α-olefins, as well as to a process for homopolymerization or copolymerization using that catalyst composition.

Polyolefins having a multi-modal or at least a broad molecular weight distribution can be obtained from a variety of methods, including, but not limited to, mechanical blending, multi-stage reactors and mixed catalysts. Such resins have several advantages over normal polyolefins lacking a multi-modal or broad molecular weight distribution. For example, polyolefins having a multi-modal molecular weight distribution (MWD) could be processed at faster throughput rate with lower energy requirements. Such polymers are preferred because of improved properties for applications such as blow molding and/or high strength films and pipes. Polymers having a multi-modal MWD are generally characterized by having a broad MWD or more than one MWD peak, as reflected by gel permeation chromatography (GPC) curves.

The most desirable method in terms of capital expense and product properties is to prepare the broad or multi-modal resin in a single reactor using a mixture of catalysts that are capable of producing the targeted polymer blend under the same polymerization conditions. This process could avoid the need for an additional reactor and controls. The broad or multi-modal polymer fractions could be mixed more efficiently, since they are produced together.

The most frequently used mixed catalyst system for bimodal resins is based on a metallocene and a Ziegler-Natta catalyst. Due to the significant differences between the two catalysts, the segregation of the polymer during polymerization process often leads to reactor fouling and it is difficult to control its process and the product produced. Polymer particles produced from such catalyst systems are frequently not uniform in size.

Use of two metallocenes in order to produce bimodal resins has also been studied. U.S. Pat. No. 4,530,914 and U.S. Pat. No. 4,975,403 disclose the use of two metallocenes and alumoxane to produce bimodal resins.

The use of titanacene and zirconocene to produce bimodal resin in the presence of hydrogen is disclosed in U.S. Pat. No. 5,064,797. U.S. Pat. No. 5,594,078 describes a catalyst system comprising a bridged fluorenyl-containing metallocene and an unbridged metallocene for the production of bimodal olefin polymers. In U.S. Pat. No. 6,150,481 it is disclosed that bimodal resin could be produced by two different metallocenes in which the indenyl was bridged through its 1-position. U.S. Pat. No. 5,914,289 discloses a catalyst system comprising a bridged and a non-bridged hydrogenated indenyl or fluorenyl metallocene together with alumoxane for use in the preparation of polyolefins having a broad monomodal molecular weight distribution. In U.S. Pat. No. 5,892,079 a metallocene catalyst system is disclosed which contains binuclear or multinuclear chemically distinct active sites.

Further, U.S. Pat. No. 5,847,059 describes a dual supported metallocene catalyst which is able to increase its activity over that for a single supported metallocene catalyst and produces only a polymer having a relatively broad molecular weight distribution.

Further, U.S. Pat. No. 6,342,622 discloses the use of particular indenyl compounds for the polymerization of olefins, which indenyl compounds are highly active catalysts giving polymers with high molecular weight. In case, a comonomer is used, this comonomer is very well incorporated into the polymer backbone.

That catalyst systems disclosed in the prior art may be used for homopolymerization of ethylene or copolymerization of ethylene with alpha-olefin(s). In general, it is difficult, due to the similarity of the metallocenes used in combination so far, to place the comonomer in the high molecular weight fraction of a copolymer. Normally, the comonomer is better incorporated in the low molecular weight fraction, because of easier chain termination after insertion of a larger comonomer into the metal-polymer bond of the catalyst.

It is an object of the present invention, to overcome the drawbacks of the prior art and to provide a catalyst composition producing polymers having a multi-modal or at least a broad molecular weight distribution with high activity, wherein the catalyst composition provides a polymerization process with excellent processability and final product control. Further, in case a comonomer is used, this comonomer shall be more effectively placed in the high molecular weight fraction.

Further, it is an object to provide a process for polymerization of α-olefins with excellent processability and product controls using the inventive catalyst composition. The process shall be carried out in a single reactor.

The first object is achieved by a catalyst composition for polymerization of olefins, comprising
a) at least two catalytic components, wherein a first catalytic component (A) is of the formula (I) 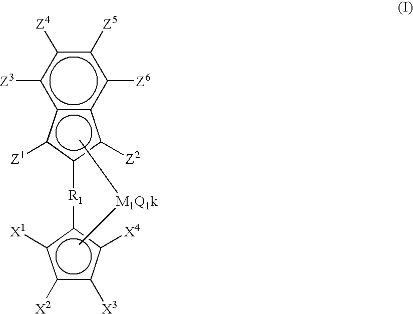
wherein: M₁ is a transition metal from the lanthanides or from group 3, 4, 5 or 6 of the Periodic System of Elements, Q₁ is an anionic ligand to M₁, k is the number of Q₁ groups and is equal to the valence of M₁ minus 2, R1 is a bridging grou and Z₁-Z₆ and X₁-X₄ are substituents, wherein R₁ contains at least one sp2-hybridized carbon atom that is bonded to the indenyl group at the 2-position, and wherein a second catalytic component (B) is also active for the polymerization of olefins and is different from the catalytic component (A); and
b) a cocatalyst.

It is more preferred that the first catalytic component (A) is of the formula (Ia) 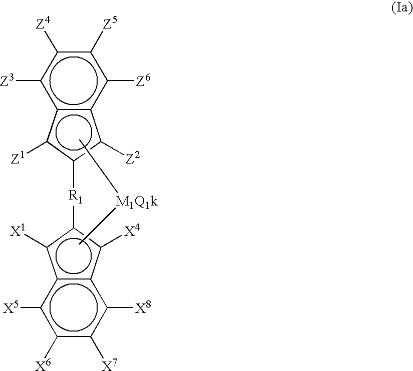
wherein Z¹ Z⁶ and X¹ and X⁴-X⁸ are substituents and R₁ contains at least one sp2-hybridized carbon atom that is bonded to one of the indenyl groups at the 2-position.

It is still preferred that R₁ is an alkylene-containing bridging group, an aryl-containing bridging group or a bisaryl-containing bridging group.

Also particularly preferred is that R₁ is ethylene, propylene, phenylene, biphenylene, pyridyl, furyl, thiophyl, or N-substituted pyrrols.

Most preferred is R₁ 2,2′-biphenylene;

In one embodiment of the invention is M₁ titanium, zirconium or hafnium.

Further it is preferred that Q₁ is Cl or a methyl group.

The second catalytic component (B) which is different from the catalytic component (A), may be a (bridged) metallocene, a constrained geometry catalyst(known as DOW-catalyst), a nickel-bisimine complex, a iron-pyridine bridged bisimine complex, a FI complex or a phosphinimine complex.

Particularly preferred, the second catalytic component (B) is selected from the group consisting of the formulas (II) to (VII) as follows: 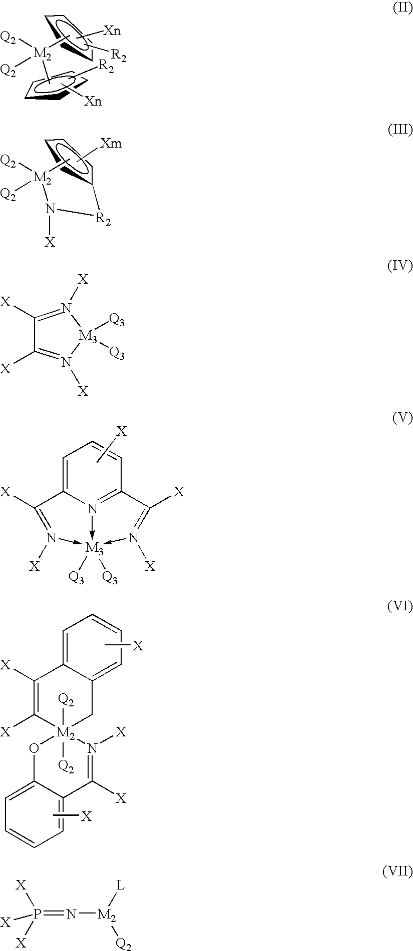
wherein M₂ is a transition metal from groups 3 to 10 of the Periodic System of the Elements, M₃ is a transition metal from group 10 of the Periodic System of the Elements, Q₂ is an anionic ligand to M₂, Q₃ is an anionic ligand to M₃, R₂ is a bridging group, X, which may be the same or different, is a substituent, n is from 1 to 5, m is from 1 to 4, L is cyclopentadienyl or its derivatives, hetero-atom substituted in a cyclopentadienyl derivatives, siloxide or phenoxide.

Most preferred, the second catalyst component (B) is Me₂Si(Ind)₂ZrCl₂, C₂H₄(Ind)₂ZrCl₂, or Me₂ Si(4H-Ind)₂ZrC₂.

The cocatalyst may be an organoaluminum compound and/or a non-coordinative ionic compound.

Further it is preferred that the cocatalyst is methylaluminoxane (MAO), modified methylaluminoxane (MMAO), triaryl borane or tetraaryl borate, such as perfluorophenyl borane and perfluorophenyl borate derivatives, or mixtures thereof.

Still preferred is that the molar ratio of the cocatalyst relative to the catalytic components, in case an organoaluminum compound is selected as the cocatalyst, is in a range of from about 1:1 to about 1000:1, preferably in a range of from about 1:1 to about 250:1, and wherein the molar ratio of the cocatalyst relative to the catalytic components, in case a non-coordinative ionic cocatalyst is selceted, is in a range of from about 1:100 to about 100:1, preferably in a range from about 1:1 to about 50:1.

Additionally it is preferred that the catalyst composition is supported on a support selected from an inorganic or organic support.

In one embodiment the support is preferably selected from the group consisting of silica, alumina, magnesia, titania, zirconia, clay, zeolithe, polystyrene, polyethylene, polypropylene, polyvinylchloride, polycarbonate; polyketone, polyvinylalcohol, polymethyl methacrylate, cellulose, graphite or mixtures thereof.

It is preferred that modifiers, promoters, electrondonor reagents, scavengers, silicon containing compounds, surfactants, antistatic regants, antioxidants or fluorine containing compounds are added.

Still preferred is that alcohols, titanates, ethers, such as tetrahydrofurane, are added.

It has to be noted that aluminumalkyl, such as triisobutyl aluminum, trihexyl aluminum, tri-isopropyl aluminum, triethyl aluminum and trimethyl aluminum, is added as scavenger or cocatalyst to the catalyst composition.

The second object is achieved by a process for homopolymerization or copolymerization of α-olefins using a catalyst composition of the invention.

It is preferrred that the α-olefin is ethylene, propylene, butene, pentene, hexene, heptene, octene or mixtures thereof.

It is still preferred that additionally one or more non-conjugated dien is present. Therefore, also amorphous or rubbery copolymers may be produced, wherein preferred dienes are 1,7 octadiene and 1,9-octadiene or norbornene derivatives.

Preferably, the process is carried out in gas phase, slurry phase or solution phase.

Finally, it is preferred that the polymerization is carried out at a temperature of about 50 to about 250° C.

The catalytic component (A) in the catalyst composition of the invention is the indenyl compound as disclosed in U.S. Pat. No. 6,342,622 which is incorporated herein by reference in its entirety.

In detail, Q₁ may comprise one or more uni- or polyvalent anionic ligands to the transition metal M₁. As examples of such ligands, which may be the same or different, the following can be mentioned: a hydrogen, a halogen, an alkyl group, an aryl group, an aralkyl group, an alkoxy group, an aryloxy group, or a group with a heteroatom chosen from group 14, 15 or 16 of the Periodic System of Elements, such as an amine group, an amide group, a sulfur-containing compound or a phosphorous-containing compound.

Q₁ may be also a monoanionic ligand bonded to M₁ via a covalent metal-carbon bond and which is additionally capable to non-covalently interact with M₁ via one or more functional groups, for example 2,6-difluorophenyl, 2,4,6-trifluorophenyl, pentafluorophenyl, 2-alkoxyphenyl, 2,6-dialkoxyphenyl, 2-(dialkylamono)benzyl and 2,6-(dialkylamino)phenyl.

The number of Q₁ groups in the catalytic component (A) (index k in formula I) is determined by the valence of M₁ and the valence of the Q₁ group itself.

The sp2-hybridized carbon atom of R₁ may be a part of, for example, an alkylene-containing bridging group R₁ or of an aryl group forming part of the bridging group R₁. Preferably, R₁ is a bisaryl group; most preferably 2,2′-biphenylene.

The substituents X₁-X₈ may be each separately hydrogen or a hydrocarbon radical with 1-20 carbon atoms, e.g. alkyl, aryl, aryl alkyl. Further, X₁-X₄ may be a halogen atom, or an alkoxy group. Also, two adjacent hydrocarbon radicals may be connected with each other in a ring system. In this way, an indenyl can be formed by connection of X₁ and X₂, X₂ and X₃, X₃ and X₄, or fluorenyl can be formed by connection of both X₁ and X₂ and X₃ and X₄. The substituent may also comprise one or more heteroatoms from group 14, 15 or 16 of the Periodic System of the Elements.

The substituents Z₁-Z₆ may each separately be a substituent as disclosed above with regard to the substituents X.

Regarding catalytic component (B), Q₂ and Q₃ may be selected from the possible group given above for Q₁. R₂ is a bridging group which may be selected from the group consisting of —(R′R″)Si—, —(R′R″)Ge—, —C(R′R″)—C(R′″R″″)—, —(R′R″)(C(R′′R″″))n-, —B(R′)—, —Al(R′)—, —P(R′)—, —P(R′)(O)—, —P(R′R″R′″)—, —N(R′)—, —O—, —S—, —Ar—; wherein R′ R“ ” may be hydrogen, hydrocarbon with C₁-C₁₀₀ carbon atoms, substituted or un-substituted, containing one ore more heteroatoms which could be linked directly to the bridging atom(s). Ar is an aromatic group which could contain heteroatom(s) and could be one or more aromatic rings joined together. X is a substituent as disclosed for X₁-X₈ given for formula (I). Any cyclopentadienyl ring shown includes cyclopentadienyl derivatives, such as indenyl, fluorenyl, heteroatom substituted cyclopentadienyl and the like.

Surprisingly, it was found that with the catalyst composition according to the invention polymers may be produced having a multi-modal or at least a broad molecular weight distribution, wherein the inventivecatalyst composition provides a high activity and easy processability and final product control. No reactor fouling is observed during the polymerization run. Using the inventive catalyst composition for the preparation of homopolymers, such as polyethylene, this results in a homopolymer having a multi-modal or at least a broad molecular weight distribution. For the preparation of copolymers, the catalytic component (B) produces high molecular weight polyolefins with high comonomer contents, wherein the catalytic component (A) produces low molecular weight polyolefins with low comonomer incorporations.

It is assumed, that the catalytic component (A) will lead to less accessible active centers for comonomers after activation, while catalytic component (B) generates an active center which is more accessible for comonomers. In the same time, these catalytic components have reversed effects in hydrogen. Therefore, resins produced according with the inventive process will have comonomer more effectively placed in the high molecular weight fraction. Since the catalytic components are activated by the same cocatalyst, the catalyst composition according to the invention is greatly simplified. The process control for the inventive catalyst composition is much easier than for bimetallic catalyst systems which contain both a metallocene and a Ziegler-Natta catalyst.

The polymers produced according to the inventive process may be used in a wide variety of products and end use applications. Preferably, the polymers include polyethylene or copolymers of ethylene with alpha-olefin, and even more preferably include bimodal polyethylene produced in a single reactor.

The catalyst composition according to the invention may be used to make polyolefins, especially polyethylene, having a weight average molecular weight of 30000 or more, preferably 50000 or more, more preferably 100000 or more with an MWD (M_{w}/Mₙ) between 3 and 80, preferably between 6 and 50, more preferably between 9 and 40, with an I₂₁ (Flow Index, as measured at 190° C.) of less than 40, a density of between about 0.89 and 0.97 g/cm³. The polymers obtained by the process of the invention have an ash content of less than about 100 ppm, more preferably less than about 75 ppm and even more preferably less than about 50 ppm.

The polyolefins obtained can be processed into films, molded articles (including pipes), sheets, wire and cable coating and the like. The films produced may further contain additives, such as slip, antiblock, antioxidants, pigments, fillers, antifog, UV stabilizers, antistats, polymer processing aids, neutralizers, lubricants, surfactants, pigments, dyes and nucleating agents. Preferred additives include silicon dioxide, synthetic silica, titanium dioxide, polydimethylsiloxane, calcium carbonate, metal stearates, calcium stearate, zinc stearate, talc, bariumsulfate, diatomaceous earth, wax, carbon black, flame retarding additives, low molecular weight resins, hydrocarbon resins, glass beads and the like.

### EXAMPLES

The following examples are intended to be illustrative of this invention only. They are, of course, not to be taken in any way limiting on the scope of this invention. Numerous changes and modifications can be made without departing from the scope of the invention as disclosed in the accompanying claims.

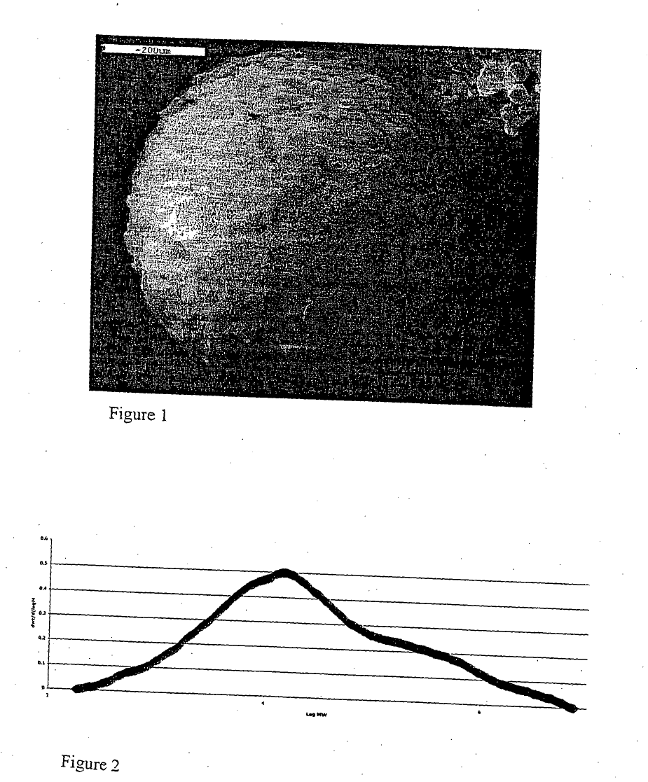

In the accompanying drawings illustrates FIG. 1 photograph of a polymer bead obtained by scanning electron microscopy and FIG. 2 shows the MWD plot of polymer obtained with the inventive catalyst composition.

All materials were handled in, a nitrogen atmosphere using either schlenk techniques or nitrogen filled glove box. Nitrogen and isopentane were supplied from a plant source and were dried through an additional bed of molecular sieves, if necessary. All other solvents were first dried over molecular sieves and if necessary sodium/potassium amalgam. The catalysts were prepared under temperature control within 0.5° C. in a silicon oil bath with stirring. Most reagents were used as received from the manufacturer or supplier. Materials were used as received by the manufacturer unless otherwise noted.

Catalyst Preparation Procedure

MAO Treated Silica:

To illustrate the preparation of a supported metallocene catalyst, 5 grams of ES70 silica which was calcinated at 600° C. and 20 mL of MAO (10% in toluene) were mixed under a nitrogen atmosphere in a 100 mL round-bottom flask equipped with a stir bar. After stirring for an, hour at 100° C., the suspension was allowed to settle down. The solvents were then removed under vacuum.

Catalyst Preparation:

A mixture of 1 mL of MAO (10% in toluene) and a certain amount of catalytic component (A) and catalytic component (B) (see Table 1 below) at room temperature was added to the 1 gram of MAO treated silica. The mixture was then stirred for 1 h at 50° C. All solvents were then removed by evacuation and the residue was washed with i-pentane three times followed by drying it under vacuum.

Following catalytic components have been used to prepare examples of the catalyst composition according to the invention:
A: [2,2′-bis(2-indenyl)biphenyl]zirconiumdichloride
B1: Me₂Si(Ind)₂ZrCI₂
B2: C₂H₄(Ind)₂ZrCl₂
B3: Me₂Si(4H-Ind)₂ZrCl₂
B4: bis(2,6-di-i-Pr)phenylpyridyliron(II)dichloride
   Polymerization Procedure

The supported catalyst was used to prepare ethylene homopolymer and copolymers of ethylene and 1-butene. The polymerizations were carried out in a two-liter stirred autoclave charged with 1000 ml dried, deoxygenated isopentane. Hydrogen was added to control molecular weight and trimethylaluminum (TMA)+triisobutylaluminum (TIBAL) were used as scavenger. Polymerizations were carried out at 88° C. and 18 bars of total pressure. Ethylene gas was used to maintain this pressure. Upon completion of the polymerization, the reactor was vented and cooled to ambient temperature to recover the polymer. Details of each polymerization and characteristics of the resins produced are provided in Table 1. A photograph made by scanning electron microscopy of a polyethylene bead of example 1 is given in FIG. 1 illustrating that a very spherical polymer bead is obtained. FIG. 2 shows the GPC curve of the polymer of example 1 indicating that example 1 provides a polymer having a very broad molecular weight distribution.

TABLE 1

| | C. Comp. | C. Comp. B | H2 | Comonomer | Productivity | Bulk Density | M_{w} |
|---|---|---|---|---|---|---|---|
| Example # | A (mmol) | (mmol) | (%) | 1-butene (ml) | (gPE/gCat.h) | (g/cc) | (MWD) |
| Example 1 | A(0.027) | B1(0.032) | 0.5 | 0 | 680 | 0.28 | 208,700 |
| | | | | | | | (37.8) |
| Example 2 | A(0.030) | B1(0.032) | 0.5 | 0 | 1060 | 0.35 | 99900 |
| | | | | | | | (9.0) |
| Example 3 | A(0.031) | B2(0.025) | 0.5 | 0 | 1320 | 0.33 | 84500 |
| | | | | | | | (10.5) |
| Example 4 | A(0.063) | B2(0.026) | 0.5 | 0 | 1930 | 0.36 | 81400 |
| | | | | | | | (11.3) |
| Example 5 | A(0.044) | B2(0.041) | 0.5 | 0 | 1330 | 0.36 | 92,000 |
| | | | | | | | (12.7) |
| Example 6 | A(0.03) | B2(0.03) | 0.25 | 40 | 1600 | — | 41,000 |
| | | | | | | | (12.6) |
| Example 7 | A(0.033) | B3(0.028) | 0.5 | 0 | 1310 | 0.25 | 34,800 |
| | | | | | | | (4.2) |
| Example 8 | A(0.03) | B4(0.05) | 0.5 | 0 | 1810 | 0.20 | 316,900 |
| | | | | | | | (3.7) |

The features disclosed in the foregoing description, in the claims and in the drawing may, both separately and in any combination thereof, be material for realizing the invention in diverse forms thereof.

1. A catalyst composition for polymerization of olefins, comprising:
at least two catalytic components, wherein a first catalytic component (A) comprises at least one indenyl group and is of the formula (I) 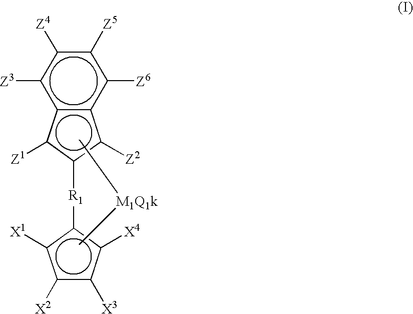
wherein: M₁ is a transition metal from the lanthanides or fromgroup 3, 4, 5 or 6 of the Periodic System of Elements, Q₁ is an anionic ligand M₁, k is the number of Q₁ groups and is equal to the valence of M₁ minus 2, R₁ is a bridging group and Z¹-Z⁶ and X¹ —X⁴ are substituents, wherein R₁ contains at least one sp2-hybridized carbon atom that is bonded to the indenyl group at the 2position, and wherein a second catalytic component (B) is also active for catalyzing the polymerization of olefins and is different from the catalytic component (A); and
b) a cocatalyst.

2. The catalyst composition according to claim 1, wherein the first catalytic component (A) is of the formula (Ia) 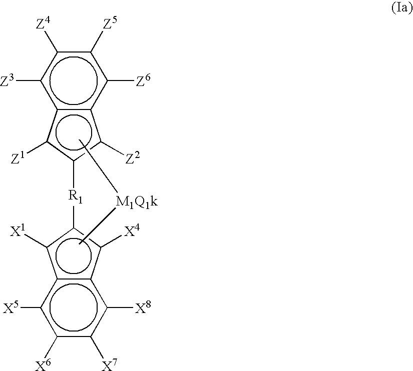
wherein Z¹-Z⁶ and X⁴-X⁸ are substituents and R₁ contains contains at least one sp2-hybridized carbon atom that is bonded to one of the indenyl groups at the 2-position.

3. The catalyst composition according to claim 1, wherein R₁ is an alkylene-containing bridging group, an aryl-containing bridging group or a bisaryl-containing bridging group.

4. The catalyst composition according to claim 3, wherein R₁ is ethylene, propylene, phenylene, biphyenylene, pyridyl, furyl, thiophyl, or N-substituted pyrrols.

5. The catalyst composition according to claim 4, wherein R₁ is 2,2′-biphenylene.

6. The catalyst composition according to claim 4, wherein M₁ is titanium, zirconium or hafnium.

7. The catalyst composition according to claim 4, wherein Q₁ is Cl or a methyl group.

8. The catalyst composition according to claim 1, wherein the second catalytic component (B) is selected from the group consisting of the formulas (II) to (VII) as follows: 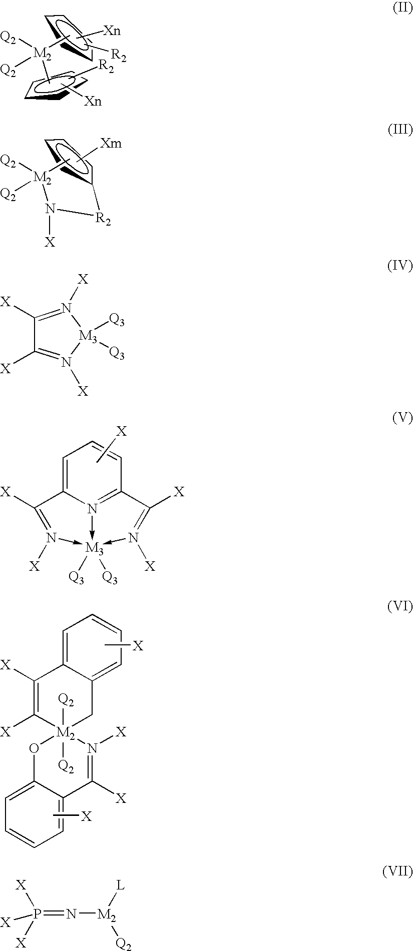
wherein M₂ is a transition metal from groups 3 to 10 of the Periodic System of the Elements, M₃ is a transition metal from the group 10 of the Periodic System of Elements, Q2 is an anionic ligand to M₂, Q₃ is an anionic ligand to M₃, R₂ is a bridging group, X is a substituent which may differ, n is from 1 to 5, m is from 1 to 4, L is a cyclopentadienyl, a hetero-atom substituted cyclopentadienyl group, a siloxide or a phenoxide.

9. The catalyst composition according to claim 8, wherein the second catalyst component (B) is Me₂Si(Ind)₂ZrCl₂, C₂H₄(Ind)₂ZRCl₂ or Me₂Si(4H-Ind)₂ZrCl₂.

10. The catalyst composition according to claim 8, wherein the cocatalyst is comprises an organoaluminum compound or a non-coordinative compound.

11. The catalyst composition according to claim 10, wherein the cocatalyst comprises methylaluminoxane (MAO), modified methylaluminoxane (MMA), triaryl borane, or tetraaryl borate.

12. (canceled)

13. The catalyst composition according to claim 11, wherein the catalyst composition is supported.

14. The catalyst composition according to claim 13, wherein the support comprises silica, alumina, magnesia, titania, zirconia, clay, zeolithe, polystyrene, polyethylene, polypropylene, polyvinylchloride, polycarbonate, polyketone, polyvinylalcohol, polymethyl methacrylate, cellulose, or graphite.

15-17. (canceled)

18. A process for homopolymerization or copolymerization of α-olefins comprising contacting at least one olefin with the catalyst composition according claim 1.

19-22. (canceled)

23. The catalyst composition according to claim 2, wherein R₁ is an alkylene-containing bridging group, an aryl-containing bridging group or a bisaryl-containing bridging group.

24. The catalyst composition according to claim 23, wherein R₁ is ethylene, propylene, phenylene, biphyenylene, pyridyl, furyl, thiophyl, or N-substituted pyrrols.

24. The catalyst composition according to claim 23, wherein R₁ is ethylene, propylene, phenylene, biphyenylene, pyridyl, furyl, thiophyl, or N-substituted pyrrols.

25. The catalyst composition according to claim 24, wherein R₁ is 2,2′-biphenylene.

26. The catalyst composition according to claim 24, wherein M₁ is titanium, zirconium or hafnium.

27. The catalyst composition according to claim 24, wherein Q₁ is Cl or a methyl group.

28. The catalyst composition according to claim 4, wherein the second catalytic component (B) is selected from the group consisting of the formulas (II) to (VII) as follows: 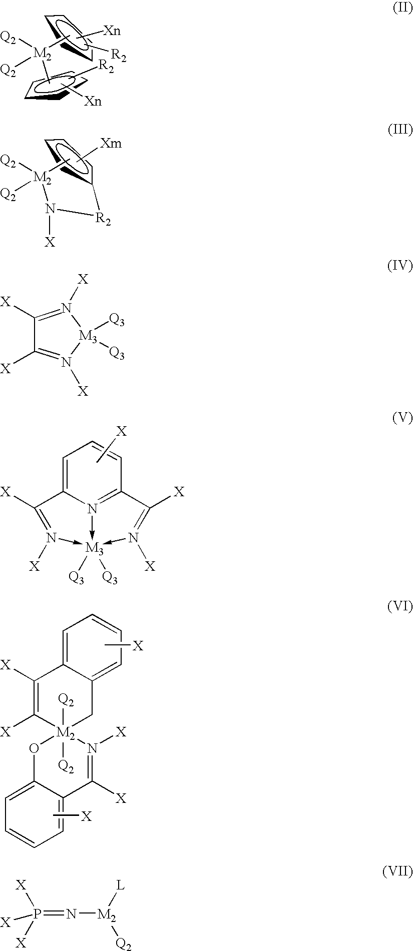
wherein M₂ is a transition metal from groups 3 to 10 of the Periodic System of the Elements, M₃ is a transition metal from the group 10 of the Periodic System of Elements, Q2 is an anionic ligand to M₂, Q₃ is an anionic ligand to M₃, R₂ is a bridging group, X, is a substituent which may differ, n is from 1 to 5, m is from 1 to 4, L is cyclopentadienyl, a hetero-atom substituted cyclopentadienyl group, a siloxide or a phenoxide.

29. The catalyst composition according to claim 28, wherein the second catalyst component (B) is Me₂Si(Ind)₂ZrCl₂, C₂H₄(Ind)₂ZRCl₂ or Me₂Si(4H-Ind)₂ZrCl₂.

30. The catalyst composition according to claim 8, wherein the cocatalyst comprises an organoaluminum compound or a non-coordinative compound.

31. The catalyst composition according to claim 30, wherein the cocatalyst comprises methylaluminoxane (MAO), modified methylaluminoxane (MMA), triaryl borane, or tetraaryl borate.

32. The catalyst composition according to claim 31, wherein the catalyst composition is supported.

33. The catalyst composition according to claim 32, wherein the support comprises silica, alumina, magnesia, titania, zirconia, clay, zeolithe, polystyrene, polyethylene, polypropylene, polyvinylchloride, polycarbonate, polyketone, polyvinylalcohol, polymethyl methacrylate, cellulose, or graphite.
